(19) United States
(12) Patent Application Publication
(10) Pub. No.: US 2014/0087125 A1
(43) Pub. Date: Mar. 27, 2014

(54) DURABLE SOFT BODY ARMOR

(71) Applicant: HENRY GERARD ARDIFF, CHESTERFIELD, VA (US)

(72) Inventor: HENRY GERARD ARDIFF, CHESTERFIELD, VA (US)

(73) Assignee: HONEYWELL INTERNATIONAL INC., Morristown, NJ (US)

(21) Appl. No.: 13/594,942

(22) Filed: Aug. 27, 2012

Related U.S. Application Data
(63) Continuation-in-part of application No. 13/072,523, filed on Mar. 25, 2011.
(60) Provisional application No. 61/531,334, filed on Sep. 6, 2011.

(51) Int. Cl. F41H 5/04; B32B 7/04

(52) U.S. Cl. CPC F41H 5/0478; B32B 7/045
USPC 428/113; 428/189; 428/190; 156/179

(57) ABSTRACT

Ballistic resistant composites having improved durability. More particularly ballistic resistant composites including a protective thermoplastic overlay that enhances composite abrasion resistance while also permitting exploitation of the properties of an underlying binder system.

### CROSS-REFERENCE TO RELATED APPLICATIONS

This application is a Continuation-in-Part of co-pending application Ser. No. 13/072,523, filed Mar. 25, 2011, the disclosure of which is incorporated by reference herein in its entirety. This application also claims the benefit of co-pending U.S. Provisional Application Ser. No. 61/531,334, filed on Sep. 6, 2011, the disclosure of which is incorporated by reference herein in its entirety.

### BACKGROUND OF THE INVENTION

1. Field of the Invention

This invention relates to ballistic resistant composites having improved durability. More particularly, the invention pertains to ballistic resistant composites including a protective thermoplastic overlay that enhances composite abrasion resistance while also permitting exploitation of the properties of an underlying binder system.

2. Description of the Related Art

Ballistic resistant articles containing high strength fibers that have excellent properties against projectiles are well known. Articles such as bullet resistant vests, helmets, vehicle panels and structural members of military equipment are typically made from fabrics comprising high strength fibers. High strength fibers conventionally used include polyethylene fibers, aramid fibers such as poly(phenylenediamine terephthalamide), graphite fibers, nylon fibers, glass fibers and the like. For many applications, such as vests or parts of vests, the fibers may be used in a woven or knitted fabric. For other applications, the fibers may be encapsulated or embedded in a polymeric binder material to form woven or non-woven rigid or soft, flexible multilayer fabrics.

The characteristics of soft, flexible body armor is known to vary depending on whether the armor is fabricated from woven fabrics or non-woven fabrics. Non-woven, unidirectional composites of fibers impregnated with a polymeric binder material are among the highest performing materials in the armor industry, and they are particularly effective for the manufacture of soft, personal body armor. Their ballistic performance is generally superior to soft, personal body armor fabricated from woven fabrics. However, some in the armor industry believe that woven fabrics have better durability, particularly better surface abrasion resistance than composites formed from non-woven fabrics. One known method of improving the abrasion resistance of non-woven fabrics is by laminating a thin, continuous polymer film, such as a polyethylene film, to the outer surfaces of the fabric. However, it has been observed that such film laminated products have a tendency to absorb water at a higher rate than unlaminated products. Alternatively, it has been known to coat the fabric surfaces with a fusible wax, such as a polyethylene wax, to improve abrasion resistance. While effective, the wax has been found to undesirably increase the stiffness of the fabric. It has also been found that such protective outer surface coatings, whether a continuous polymer film or a wax, tend to interfere with any underlying chemical resistant coatings or environmentally resistant binder systems below the protective outer surface coating. Accordingly, there is a need in the art for a new technique to improve the durability of soft body armor without increasing the fabric stiffness while also allowing other beneficial fabric properties, such as chemical resistant coatings or environmentally resistant binder systems, to be exploited. The invention provides a solution to this need in the art.

The present invention provides ballistic resistant articles having at least one thermoplastic overlay bonded to said outer top surface and/or said outer bottom surface, wherein said at least one thermoplastic overlay only partially covers the outer surfaces of the fabric. This has been found to markedly improve the abrasion resistance and durability of fabrics, without interfering with the chemical and/or environmental resistance properties of the fabric.

### SUMMARY OF THE INVENTION

The invention provides a ballistic resistant article comprising:

a) a fibrous composite comprising at least one fiber layer, each fiber layer comprising a plurality of fibers and a polymeric material on a surface of and surrounding the fibers; said fibrous composite having an outer top surface and an outer bottom surface; and
b) at least one thermoplastic overlay bonded to said outer top surface and/or said outer bottom surface, wherein said at least one thermoplastic overlay only partially covers said outer top surface and/or said outer bottom surface.

The invention also provides a method of producing a ballistic resistant article, comprising:

a) providing a fibrous composite comprising at least one fiber layer, each fiber layer comprising a plurality of fibers and a polymeric material on a surface of and surrounding the fibers; said fibrous composite having an outer top surface and an outer bottom surface;
b) applying at least one thermoplastic overlay onto said outer top surface and/or said outer bottom surface such that said at least one thermoplastic overlay only partially covers said outer top surface and/or said outer bottom surface; and
c) bonding the at least one thermoplastic overlay to said outer top surface and/or said outer bottom surface.

The invention further provides a ballistic resistant article comprising:

a) a fibrous composite comprising at least one fiber layer, each fiber layer comprising a plurality of fibers, said fibrous composite having an outer top surface and an outer bottom surface; and
b) at least one thermoplastic overlay bonded to said outer top surface and/or said outer bottom surface, wherein said at least one thermoplastic overlay only partially covers said outer top surface and/or said outer bottom surface.

### DETAILED DESCRIPTION OF THE INVENTION

The invention presents a method for modifying the outer surfaces of fibrous composites and the resulting ballistic resistant articles having improved durability. Said fibrous composites may be woven or non-woven, and may or may not be impregnated with a polymeric binder material that coats the surfaces of the component fibers of the composite. The invention is particularly useful for improving the durability of non-woven fabrics comprising a plurality of fiber layers, each fiber layer comprising a plurality of fibers and a polymeric material on a surface of and surrounding the fibers. A “fiber layer” as used herein may comprise a single-ply of unidirectionally oriented fibers, a plurality of non-consolidated plies of unidirectionally oriented fibers, a plurality of consolidated plies of unidirectionally oriented fibers, a woven fabric, a plurality of consolidated woven fabrics, or any other fabric structure that has been formed from a plurality of fibers, including felts, mats and other structures comprising randomly oriented fibers. A “layer” describes a generally planar arrangement. Each fiber layer will have both an outer top surface and an outer bottom surface. A “single-ply” of unidirectionally oriented fibers comprises an arrangement of non-overlapping fibers that are aligned in a unidirectional, substantially parallel array. This type of fiber arrangement is also known in the art as a “unitape” (unidirectional tape). As used herein, an “array” describes a side-by-side, orderly arrangement of fibers or yarns, and a “parallel array” describes an orderly parallel arrangement of fibers or yarns. The term “oriented” as used in the context of “oriented fibers” refers to the alignment of the fibers as opposed to stretching of the fibers.

For the purposes of the present invention, a “fiber” is an elongate body the length dimension of which is much greater than the transverse dimensions of width and thickness. The cross-sections of fibers for use in this invention may vary widely, and they may be circular, flat or oblong in cross-section. Thus the term “fiber” includes filaments, ribbons, strips and the like having regular or irregular cross-section, but it is preferred that the fibers have a substantially circular cross-section. As used herein, the term “yarn” is defined as a single strand consisting of multiple fibers. A single fiber may be formed from just one filament or from multiple filaments. A fiber formed from just one filament is referred to herein as either a “single-filament” fiber or a “monofilament” fiber, and a fiber formed from a plurality of filaments is referred to herein as a “multifilament” fiber.

The term “fabric” describes structures that may include one or more fiber plies, with or without molding or consolidation of the plies. For example, a woven fabric or felt may comprise a single fiber ply. A non-woven fabric formed from unidirectional fibers typically comprises a plurality of fiber plies stacked on each other and consolidated. When used herein, a “single-layer” structure refers to a monolithic structure composed of one or more individual plies, wherein multiple individual plies have been consolidated into a single unitary structure together with a polymeric binder material. By “consolidating” it is meant that the polymeric binder material together with each fiber ply is combined into a single unitary layer. Consolidation can occur via drying, cooling, heating, pressure or a combination thereof. Heat and/or pressure may not be necessary, as the fibers or fabric layers may just be glued together, as is the case in a wet lamination process. The term “composite” refers to combinations of fibers with at least one polymeric binder material. A “complex composite” as used herein refers to a consolidated combination of a plurality of fiber layers. As described herein, “non-woven” fabrics include all fabric structures that are not formed by weaving. For example, non-woven fabrics may comprise a plurality of unitapes that are at least partially coated with a polymeric binder material, stacked/overlapped and consolidated into a single-layer, monolithic element, as well as a felt or mat comprising non-parallel, randomly oriented fibers that are (preferably) coated with a polymeric binder composition. As used herein, a “thermoplastic overlay” refers to any thermoplastic material that may be attached to a surface of a fabric or fiber layer which only partially covers said surface. Such specifically excludes continuous non-porous films that cover the full fabric/fiber layer surface and are impenetrable to environmental elements such as water and organic solvents. However, it is within the scope of the invention for just one outer fabric/fiber layer surface to be coated with a continuous film while the other outer fabric/fiber layer surface is partially covered by an overlay as described herein, or for one outer surface to have no covering while the other outer surface is partially covered by an overlay. It is most preferred for both outer fabric/fiber layer surfaces to be partially covered by an overlay as described herein such that a portion of the underlying polymeric binder material (if present) is exposed through said at least one thermoplastic overlay. It is also within the scope of the invention for fibrous composites comprising a plurality of fiber layers to have a continuous polymeric film present between some or all adjacent fiber layers.

While expressly not a continuous non-porous film, the thermoplastic overlay may have any structure without exception so long as the surface to which it is applied is only partially covered. This can be, for example, a discontinuous thermoplastic web, an ordered discontinuous thermoplastic net, a non-woven discontinuous fabric, a non-woven discontinuous scrim, a discontinuous melted powder, a porous film or a plurality of thermoplastic polymer strips. When a plurality of thermoplastic polymer strips are applied, each strip is one overlay. These materials may be bonded to the fabric/fiber layer by a variety of methods including, but not limited to, thermal lamination through a calender nip or a flat-bed laminator, or wet lamination as part of the coating process where the resin binder is applied to the fiber. Alternately, a coating of a discontinuous fusible powder of a thermoplastic resin or binder may be applied to the outer surface, with subsequent bonding, melting and/or fusing of the powder to the surface, such as via a flat-bed laminator. These preferred methods are only non-limiting examples of potential techniques and are not intended to be a comprehensive listing of all useful methods for accomplishing the stated goals. It should be further understood that the fiber ply/fiber layer consolidation and polymer application/bonding steps may comprise either two separate steps or a single consolidation/lamination step.

The overlay may be applied onto either one or both outer surfaces of a fabric/fiber layer depending on need. It may also be applied onto a plurality of fibers that are arranged in an array but which may or may not be considered to be a fabric at the time of coating. A plurality of overlays may also be applied on top of each other, as long as the combined overlays only partially cover the outer top surface and/or said outer bottom surface to which they are applied. Bonding of the thermoplastic overlay to the fabric/fiber layer may generally take place at any stage of the process. For example, when a ballistic resistant article is formed which comprises a plurality of fiber layers or fiber plies consolidated with a polymeric binder material, which is most common for the fabrication of ballistic resistant articles, the thermoplastic overlay may be bonded to an outer fiber layer/ply of the article i) before a consolidation step which consolidates a plurality of fiber layers/plies and the polymeric binder material into a composite, or ii) in-line during a consolidation step which consolidates the plurality of fiber layers/plies and the polymeric binder material into a composite, or iii) after a consolidation step which consolidates the plurality of fiber layers/plies and the polymeric binder material into a composite.

The fiber layers and composites formed therefrom preferably comprise ballistic resistant composites formed from high-strength, high tensile modulus polymeric fibers. Most preferably, the fibers comprise high strength, high tensile modulus fibers which are useful for the formation of ballistic resistant materials and articles. As used herein, a “high-strength, high tensile modulus fiber” is one which has a preferred tenacity of at least about 7 g/denier or more, a preferred tensile modulus of at least about 150 g/denier or more, and preferably an energy-to-break of at least about 8 J/g or more, each both as measured by ASTM D2256. As used herein, the term “denier” refers to the unit of linear density, equal to the mass in grams per 9000 meters of fiber or yarn. As used herein, the term “tenacity” refers to the tensile stress expressed as force (grams) per unit linear density (denier) of an unstressed specimen. The “initial modulus” of a fiber is the property of a material representative of its resistance to deformation. The term “tensile modulus” refers to the ratio of the change in tenacity, expressed in grams-force per denier (g/d) to the change in strain, expressed as a fraction of the original fiber length (in/in).

The polymers forming the fibers are preferably high-strength, high tensile modulus fibers suitable for the manufacture of ballistic resistant composites/fabrics. Particularly suitable high-strength, high tensile modulus fiber materials that are particularly suitable for the formation of ballistic resistant composites and articles include polyolefin fibers, including high density and low density polyethylene. Particularly preferred are extended chain polyolefin fibers, such as highly oriented, high molecular weight polyethylene fibers, particularly ultra-high molecular weight polyethylene fibers, and polypropylene fibers, particularly ultra-high molecular weight polypropylene fibers. Also suitable are aramid fibers, particularly para-aramid fibers, polyamide fibers, polyethylene terephthalate fibers, polyethylene naphthalate fibers, extended chain polyvinyl alcohol fibers, extended chain polyacrylonitrile fibers, polybenzazole fibers, such as polybenzoxazole (PBO) and polybenzothiazole (PBT) fibers, liquid crystal copolyester fibers and other rigid rod fibers such as M5® fibers. Each of these fiber types is conventionally known in the art. Also suitable for producing polymeric fibers are copolymers, block polymers and blends of the above materials.

The most preferred fiber types for ballistic resistant fabrics include polyethylene, particularly extended chain polyethylene fibers, aramid fibers, polybenzazole fibers, liquid crystal copolyester fibers, polypropylene fibers, particularly highly oriented extended chain polypropylene fibers, polyvinyl alcohol fibers, polyacrylonitrile fibers and other rigid rod fibers, particularly M5® fibers. Specifically most preferred fibers are aramid fibers.

In the case of polyethylene, preferred fibers are extended chain polyethylenes having molecular weights of at least 500,000, preferably at least one million and more preferably between two million and five million. Such extended chain polyethylene (ECPE) fibers may be grown in solution spinning processes such as described in U.S. Pat. No. 4,137,394 or 4,356,138, which are incorporated herein by reference, or may be spun from a solution to form a gel structure, such as described in U.S. Pat. Nos. 4,551,296 and 5,006,390, which are also incorporated herein by reference. A particularly preferred fiber type for use in the invention are polyethylene fibers sold under the trademark SPECTRA® from Honeywell International Inc. SPECTRA® fibers are well known in the art and are described, for example, in U.S. Pat. Nos. 4,623,547 and 4,748,064. In addition to polyethylene, another useful polyolefin fiber type is polypropylene (fibers or tapes), such as TEGRIS® fibers commercially available from Milliken & Company of Spartanburg, S.C.

Also particularly preferred are aramid (aromatic polyamide) or para-aramid fibers. Such are commercially available and are described, for example, in U.S. Pat. No. 3,671,542. For example, useful poly(p-phenylene terephthalamide) filaments are produced commercially by DuPont under the trademark of KEVLAR®. Also useful in the practice of this invention are poly(m-phenylene isophthalamide) fibers produced commercially by DuPont under the trademark NOMEX® and fibers produced commercially by Teijin under the trademark TWARON®; aramid fibers produced commercially by Kolon Industries, Inc. of Korea under the trademark HERACRON®; p-aramid fibers SVM™ and RUSAR™ which are produced commercially by Kamensk Volokno JSC of Russia and ARMOS™ p-aramid fibers produced commercially by JSC Chim Volokno of Russia.

Suitable polybenzazole fibers for the practice of this invention are commercially available and are disclosed for example in U.S. Pat. Nos. 5,286,833, 5,296,185, 5,356,584, 5,534,205 and 6,040,050, each of which is incorporated herein by reference. Suitable liquid crystal copolyester fibers for the practice of this invention are commercially available and are disclosed, for example, in U.S. Pat. Nos. 3,975,487; 4,118,372 and 4,161,470, each of which is incorporated herein by reference. Suitable polypropylene fibers include highly oriented extended chain polypropylene (ECPP) fibers as described in U.S. Pat. No. 4,413,110, which is incorporated herein by reference. Suitable polyvinyl alcohol (PV-OH) fibers are described, for example, in U.S. Pat. Nos. 4,440,711 and 4,599,267 which are incorporated herein by reference. Suitable polyacrylonitrile (PAN) fibers are disclosed, for example, in U.S. Pat. No. 4,535,027, which is incorporated herein by reference. Each of these fiber types is conventionally known and is widely commercially available.

M5® fibers are formed from pyridobisimidazole-2,6-diyl (2,5-dihydroxy-p-phenylene) and are manufactured by Magellan Systems International of Richmond, Va. and are described, for example, in U.S. Pat. Nos. 5,674,969, 5,939,553, 5,945,537, and 6,040,478, each of which is incorporated herein by reference. Also suitable are combinations of all the above materials, all of which are commercially available. For example, the fibrous layers may be formed from a combination of one or more of aramid fibers, UHMWPE fibers (e.g. SPECTRA® fibers), carbon fibers, etc., as well as fiberglass and other lower-performing materials.

The fibers may be of any suitable denier, such as, for example, 50 to about 3000 denier, more preferably from about 200 to 3000 denier, still more preferably from about 650 to about 2000 denier, and most preferably from about 800 to about 1500 denier. The selection is governed by considerations of ballistic effectiveness and cost. Finer fibers are more costly to manufacture and to weave, but can produce greater ballistic effectiveness per unit weight.

As stated above, a high-strength, high tensile modulus fiber is one which has a preferred tenacity of about 7 g/denier or more, a preferred tensile modulus of about 150 g/denier or more and a preferred energy-to-break of about 8 J/g or more, each as measured by ASTM D2256. In the preferred embodiment of the invention, the tenacity of the fibers should be about 15 g/denier or more, preferably about 20 g/denier or more, more preferably about 25 g/denier, still more preferably about 30 g/denier or more, still more preferably about 37 g/denier or more still more preferably about 40 g/denier or more still more preferably about 45 g/denier or more still more preferably about 50 g/denier or more still more preferably about 55 g/denier or more and most preferably about 60 g/denier or more. Preferred fibers also have a preferred tensile modulus of about 300 g/denier or more, more preferably about 400 g/denier or more, more preferably about 500 g/denier or more, more preferably about 1,000 g/denier or more and most preferably about 1,500 g/denier or more. Preferred fibers also have a preferred energy-to-break of about 15 J/g or more, more preferably about 25 J/g or more, more preferably about 30 J/g or more and most preferably have an energy-to-break of about 40 J/g or more. These combined high strength properties are obtainable by employing well known processes. U.S. Pat. Nos. 4,413,110, 4,440,711, 4,535,027, 4,457,985, 4,623,547 4,650,710 and 4,748,064 generally discuss the formation of preferred high strength, extended chain polyethylene fibers. Such methods, including solution grown or gel fiber processes, are well known in the art. Methods of forming each of the other preferred fiber types, including para-aramid fibers, are also conventionally known in the art, and the fibers are commercially available.

The polymeric binder impregnating the fiber layers either partially or substantially coats the individual fibers of the fiber layers. The polymeric binder material is also commonly known in the art as a “polymeric matrix” material, and these terms are used interchangeably herein. These terms are conventionally known in the art and describe a material that binds fibers together either by way of its inherent adhesive characteristics or after being subjected to well known heat and/or pressure conditions. Such a “polymeric matrix” or “polymeric binder” material may also provide a fabric with other desirable properties, such as abrasion resistance and resistance to deleterious environmental conditions, so it may be desirable to coat the fibers with such a binder material even when its binding properties are not important, such as with woven fabrics. It is generally necessary to impregnate or coat woven fabrics with some form of polymeric binder material if it is desired to merge multiple woven fabrics by low pressure lamination or high pressure molding or lamination. Accordingly, to merge multiple woven fabrics, the fibers comprising the woven fabrics are preferably at least partially coated with a polymeric binder, followed by a consolidation step similar to that conducted with non-woven fiber layers.

Suitable polymeric binder materials include both low modulus, elastomeric materials and high modulus, rigid materials. As used herein throughout, the term tensile modulus means the modulus of elasticity as measured by ASTM 2256 for a fiber and by ASTM D638 for a polymeric binder material. A low or high modulus binder may comprise a variety of polymeric and non-polymeric materials. A preferred polymeric binder comprises a low modulus elastomeric material. For the purposes of this invention, a low modulus elastomeric material has a tensile modulus measured at about 6,000 psi (41.4 MPa) or less according to ASTM D638 testing procedures. A low modulus polymer preferably has, the tensile modulus of the elastomer is about 4,000 psi (27.6 MPa) or less, more preferably about 2400 psi (16.5 MPa) or less, more preferably 1200 psi (8.23 MPa) or less, and most preferably is about 500 psi (3.45 MPa) or less. The glass transition temperature (Tg) of the elastomer is preferably less than about 0° C., more preferably the less than about −40° C., and most preferably less than about −50° C. The elastomer also has a preferred elongation to break of at least about 50%, more preferably at least about 100% and most preferably has an elongation to break of at least about 300%.

A wide variety of materials and formulations having a low modulus may be utilized as the polymeric binder. Representative examples include polybutadiene, polyisoprene, natural rubber, ethylene-propylene copolymers, ethylene-propylene-diene terpolymers, polysulfide polymers, polyurethane elastomers, chlorosulfonated polyethylene, polychloroprene, plasticized polyvinylchloride, butadiene acrylonitrile elastomers, poly(isobutylene-co-isoprene), polyacrylates, polyesters, polyethers, fluoroelastomers, silicone elastomers, copolymers of ethylene, polyamides (useful with some fiber types), acrylonitrile butadiene styrene, polycarbonates, and combinations thereof, as well as other low modulus polymers and copolymers curable below the melting point of the fiber. Also preferred are blends of different elastomeric materials, or blends of elastomeric materials with one or more thermoplastics.

Particularly useful are block copolymers of conjugated dienes and vinyl aromatic monomers. Butadiene and isoprene are preferred conjugated diene elastomers. Styrene, vinyl toluene and t-butyl styrene are preferred conjugated aromatic monomers. Block copolymers incorporating polyisoprene may be hydrogenated to produce thermoplastic elastomers having saturated hydrocarbon elastomer segments. The polymers may be simple tri-block copolymers of the type A-B-A, multi-block copolymers of the type (AB)ₙ (n=2-10) or radial configuration copolymers of the type R−(BA)ₓ (x=3-150); wherein A is a block from a polyvinyl aromatic monomer and B is a block from a conjugated diene elastomer. Many of these polymers are produced commercially by Kraton Polymers of Houston, Tex. and described in the bulletin “Kraton Thermoplastic Rubber”, SC-68-81. Also useful are resin dispersions of styrene-isoprene-styrene (SIS) block copolymer sold under the trademark PRINLIN® and commercially available from Henkel Technologies, based in Düsseldorf, Germany. Particularly preferred low modulus polymeric binder polymer comprises styrenic block copolymers sold under the trademark KRATON® commercially produced by Kraton Polymers. The most preferred polymeric binder material comprises a polystyrene-polyisoprene-polystyrene-block copolymer sold under the trademark KRATON®.

Also particularly preferred are polymeric binder materials that are resistant to dissolution by water, particularly sea water, and/or resistant to dissolution by one or more organic solvents, such as diesel or non-diesel gasoline, gun lube, petroleum and organic solvents derived from petroleum. These binder materials assist in the merging of fibers and fiber layers as well as provide a composite material having good resistance to degradation due to environmental contaminants. Polymers which are both polar and hydrolytically stable exhibit both water resistance and organic solvent resistance, while maintaining the desired ballistic resistance properties necessary for an effective ballistic resistant article. Polar polymers are generally resistant to dissolution by non-polar organic solvents, and hydrolytically stable polymers are stable to hydrolysis by water, i.e. resistant to chemical decomposition when exposed to water. Accordingly, ballistic resistant articles formed incorporating such polymeric matrix materials retain their ballistic resistance properties after prolonged exposure to such liquids.

Suitable dissolution resistant polymeric matrix materials preferably include polar modified synthetic rubbers, polar modified diene rubbers and polar modified styrenic block copolymers including styrene-isoprene-styrene (SIS) and styrene-butadiene-styrene (SBS), polar vinyl-based polymers, polar acrylic polymers, polyvinyl chloride homopolymer, polyvinyl chloride copolymer, polyvinyl chloride terpolymer, polyvinyl butyral, polyvinylidene chloride, polyvinylidene fluoride polar ethylene vinyl acetate copolymers, polar ethylene acrylic acid copolymers, silicone, thermoplastic polyurethanes, nitrile rubber, polychloroprenes such as Neoprene (manufactured by DuPont), polycarbonates, polyketones, polyamides, cellulosics, polyimides, polyesters, epoxies, alkyds, phenolics, polyacrylonitrile, polyether sulfones and combinations thereof. Also suitable are other polar, hydrolytically stable polymers not specified herein. Non-polar synthetic rubbers and styrenic block copolymers, such as SIS and SBS, generally should be modified with polar groups, such as by the grafting of carboxyl groups or adding acid or alcohol functionality, or any other polar group, to be sufficiently oil repellant. For example, non-polar polymers may be copolymerized with monomers containing carboxylic acid groups such as acrylic acid or maleic acid, or another polar group such as amino, nitro or sulfonate groups. Such techniques are well known in the art.

Particularly preferred are polar polymers which have a C-C polymer backbone. As stated herein, polar polymers are generally resistant to dissolution by non-polar organic solvents. Polymers having a C-C-backbone, such as vinyl-based polymers including, for example, acrylics, ethylene vinyl acetate, polyvinylidene chloride, etc., have a hydrolytically stable molecular structure. Also particularly preferred are polar, thermoplastic polyurethanes, particularly those that have been formulated to enhance hydrolytic stability. Unlike C-C linkages, urethane linkages and ester linkages are generally susceptible hydrolytic degradation. Accordingly, polymers having such linkages generally are formulated or modified to enhance water repellency and hydrolytic stability. For example, polyurethanes may be formulated to enhance hydrolytic stability through copolymerization with polyether polyol or aliphatic polyol components, or other components known to enhance hydrolytic stability. The main polyurethane producing reaction is between an aliphatic or aromatic diisocyanate and a polyol, typically a polyethylene glycol or polyester polyol, in the presence of catalysts. Selection of the isocyanate co-reactant can also influence the hydrolytic stability. Bulky pendant groups on either or both of the co-reactants can also protect the urethane linkage from attack. Polyurethane can be made in a variety of densities and hardnesses by varying the type of monomers used and by adding other substances to modify their characteristics or enhance their hydrolytic stability, such as with water repellants, pH buffers, cross-linking agents and chelating agents, etc.

The thermoplastic polyurethane may be a homopolymer, a copolymer, or a blend of a polyurethane homopolymer and a polyurethane copolymer. Such polymers are commercially available. Such polyurethanes are generally available as aqueous solutions, dispersions or emulsions, in which the solids component may range from about 20% to 80% by weight, more preferably from about 40% to about 60% by weight, with the remaining weight being water. An aqueous system is preferred for ease of use. Most specifically preferred are polar polyurethanes within the range of both soft and rigid materials at a tensile modulus ranging from about 2,000 psi (13.79 MPa) to about 8,000 psi (55.16 MPa). Preferred polyurethanes are applied as aqueous polyurethane dispersions that are most preferably, but not necessarily, cosolvent free. Such includes aqueous anionic polyurethane dispersions, aqueous cationic polyurethane dispersions and aqueous nonionic polyurethane dispersions. Particularly preferred are aqueous anionic polyurethane dispersions; aqueous aliphatic polyurethane dispersions, and most preferred are aqueous anionic, aliphatic polyurethane dispersions, all of which are preferably cosolvent free dispersions. Such includes aqueous anionic polyester-based polyurethane dispersions; aqueous aliphatic polyester-based polyurethane dispersions; and aqueous anionic, aliphatic polyester-based polyurethane dispersions, all of which are preferably cosolvent free dispersions. Such also includes aqueous anionic polyether polyurethane dispersions; aqueous aliphatic polyether-based polyurethane dispersions; and aqueous anionic, aliphatic polyether-based polyurethane dispersions, all of which are preferably cosolvent free dispersions. Similarly preferred are all corresponding variations (polyester-based; aliphatic polyester-based; polyether-based; aliphatic polyether-based, etc.) of aqueous cationic and aqueous nonionic dispersions. Most preferred is an aliphatic polyurethane dispersion having a modulus at 100% elongation of about 700 psi or more, with a particularly preferred range of 700 psi to about 3000 psi. More preferred are aliphatic polyurethane dispersions having a modulus at 100% elongation of about 1000 psi or more, and still more preferably about 1100 psi or more. The most preferred polyurethane matrix material comprises a polar, hydrolytically stable, polyether- or aliphatic-based thermoplastic polyurethane, which are preferred over polyester-based polyurethanes, particularly an aliphatic, polyether-based anionic polyurethane dispersion having a modulus of 1000 psi or more, preferably 1100 psi or more.

Also preferred are fluorine-containing polymers which are desirable for their resistance to dissolution, penetration and/or transpiration by sea water and resistance to dissolution, penetration and/or transpiration by one or more organic solvents. Useful fluorine-containing polymers include fluoropolymers and fluorocarbon resin materials. Useful fluoropolymers and fluorocarbon resin materials include fluoropolymer homopolymers, fluoropolymer copolymers or blends thereof as are well known in the art and are described in, for example, U.S. Pat. Nos. 4,510,301, 4,544,721 and 5,139,878. Examples of useful fluoropolymers include, but are not limited to, homopolymers and copolymers of chlorotrifluoroethylene, ethylene-chlorotrifluoroethylene copolymer, ethylene-tetrafluoroethylene copolymer, fluorinated ethylene-propylene copolymer, perfluoroalkoxyethylene, polychlorotrifluoroethylene, polytetrafluoroethylene, polyvinyl fluoride, polyvinylidene fluoride, and copolymers and blends thereof.

As used herein, copolymers include polymers having two or more monomer components. Preferred fluoropolymers include homopolymers and copolymers of polychlorotrifluoroethylene. Particularly preferred are PCTFE (polychlorotrifluoroethylene homopolymer) materials sold under the ACLON™ trademark and which are commercially available from Honeywell International Inc. of Morristown, N.J. The most preferred fluoropolymers or fluorocarbon resins include fluorocarbon-modified polymers, particularly fluoro-oligomers and fluoropolymers formed by grafting fluorocarbon side-chains onto conventional polyethers (i.e. fluorocarbon-modified polyethers), polyesters (i.e. fluorocarbon-modified polyesters), polyanions (i.e. fluorocarbon-modified polyanions) such as polyacrylic acid (i.e. fluorocarbon-modified polyacrylic acid) or polyacrylates (i.e. fluorocarbon-modified polyacrylates), and polyurethanes (i.e. fluorocarbon-modified polyurethanes). These fluorocarbon side chains or perfluoro compounds are generally produced by a telomerisation process and are referred to as C₈ fluorocarbons. For example, a fluoropolymer or fluorocarbon resin may be derived from the telomerisation of an unsaturated fluoro-compound, forming a fluorotelomer, where said fluorotelomer is further modified to allow reaction with a polyether, polyester, polyanion, polyacrylic acid, polyacrylate or polyurethane, and where the fluorotelomer is then grafted onto a polyether, polyester, polyanion, polyacrylic acid, polyacrylate or polyurethane. Good representative examples of these fluorocarbon-containing polymers are NUVA® fluoropolymer products, commercially available from Clariant International, Ltd. of Switzerland. Other fluorocarbon resins, fluoro-oligomers and fluoropolymers having perfluoro acid-based and perfluoro alcohol-based side chains are also most preferred. Fluoropolymers and fluorocarbon resins having fluorocarbon side chains of shorter lengths, such as C₆, C₄ or C₂, are also suitable, such as PolyFox™ fluorochemicals, commercially available from Omnova Solutions, Inc. of Fairlawn, Ohio. Particularly preferred polymeric binder materials are blends of a fluoropolymer or fluorocarbon-containing resin and at least one non-fluorocarbon-containing polymeric material, such as polyurethane or a styrenic copolymer.

Also preferred for their environmental resistance are polymeric binder materials comprising nitrile rubber, preferably an uncured (non-crosslinked) nitrile rubber. Cured or crosslinked nitrile rubbers have a higher modulus than uncured nitrile rubbers and, accordingly, are stiffer than uncured materials, which is a concern in some soft body armor applications. Nitrile rubber polymers are particularly desirable because they achieve the desired resistance to water, e.g. salt water, and organic solvents such as gasoline, while imparting good peel strength and flexibility to the fabrics, both of which are indications of excellent durability. Nitrile rubber polymers are a family of unsaturated copolymers of acrylonitrile and butadiene and many different types are available having different properties. For example, resistance to organic solvents such as oil and gasoline may be controlled and balanced with other properties, such as resistance to extreme temperatures, by regulating the acrylonitrile content of the nitrile rubber versus the butadiene content. Due to its polarity, a nitrile rubber having a higher acrylonitrile content has better resistance to oils and gasoline than nitrile rubbers with lower acrylonitrile content, and also increases tensile strength. Nitrile rubbers having a lower acrylonitrile content also exhibit good resistance to oils and gasoline, though not as good as high acrylonitrile content polymers, but exhibit excellent flexibility and resilience, while high acrylonitrile content polymers exhibit higher stiffness and lower flexibility. For soft armor applications, the nitrile rubber preferably has an acrylonitrile content of from about 15 wt. % to about 30 wt. %, more preferably from about 20 wt. % to about 30 wt. %. For hard armor applications, the nitrile rubber preferably has a preferred acrylonitrile content of from about 31 wt. % to about 50 wt. %, more preferably from about 40 wt. % to about 50 wt. %. Nitrile rubber binders with a high acrylonitrile content generally have a higher tensile modulus than low acrylonitrile materials and accordingly are particularly well suited for rigid armor applications. Also, crosslinked nitrile rubbers have a higher tensile modulus than non-crosslinked rubbers.

Preferred nitrile rubber polymers comprise nitrile rubber terpolymers comprising an acrylonitrile monomer, a butadiene monomer and another monomer component, such as N-methylol acrylamide or a carboxylic acid, such as methacrylic acid. Preferably the nitrile rubber comprises a carboxylated nitrile rubber (XNBR) terpolymer. Such terpolymers are well known in the art and are commercially available, for example, from Dow Reichhold Specialty Latex, LLC. of Research Triangle Park, N.C., under the trademark TYLAC® 68073. Useful carboxylated nitrile rubber terpolymers are also described, for example, in U.S. Pat. Nos. 6,127,469, 6,548,604 and 7,030,193, the disclosures of which are incorporated herein by reference. Another preferred terpolymer comprises an acrylonitrile monomer, a butadiene monomer and N-methylol acrylamide (NMA). One example of this type of terpolymer is HYCAR® 1572X64, commercially available from Emerald Performance Materials of Akron, Ohio. Other useful terpolymers of this type are described, for example, in U.S. Pat. No. 5,783,625 and Canadian patent CA1190343, the disclosures of which are incorporated herein by reference. Optionally, the nitrile rubbers of the invention may be hydrogenated to improve durability and environmental resistance. Particularly, hydrogenated nitrile rubbers (HNBR) have excellent mechanical, thermo-oxidative and chemical resistant properties and an excellent operating temperature range. Hydrogenated nitrile rubbers are well known in the art.

As the thermoplastic overlay only partially covers the outer top surface and/or the outer bottom surface of the fibrous composite, a portion of the underlying composite and its polymeric material will be exposed through the overlay, or between multiple overlays. As stated previously, this exposure through the overlay permits exploitation of the benefits of the particularly selected binder material.

While low modulus polymeric matrix binder materials are most useful for the formation of flexible armor, such as ballistic resistant vests, high modulus, rigid materials useful for forming hard armor articles, such as helmets, are particularly preferred herein. Preferred high modulus, rigid materials generally have a higher initial tensile modulus than 6,000 psi. Preferred high modulus, rigid polymeric binder materials useful herein include polyurethanes (both ether and ester based), epoxies, polyacrylates, phenolic/polyvinyl butyral (PVB) polymers, vinyl ester polymers, styrene-butadiene block copolymers, as well as mixtures of polymers such as vinyl ester and diallyl phthalate or phenol formaldehyde and polyvinyl butyral. A particularly preferred rigid polymeric binder material for use in this invention is a thermosetting polymer, preferably soluble in carbon-carbon saturated solvents such as methyl ethyl ketone, and possessing a high tensile modulus when cured of at least about 1×10⁶ psi (6895 MPa) as measured by ASTM D638. Particularly preferred rigid polymeric binder materials are those described in U.S. Pat. No. 6,642,159, the disclosure of which is incorporated herein by reference. The polymeric binder, whether a low modulus material or a high modulus material, may also include fillers such as carbon black or silica, may be extended with oils, or may be vulcanized by sulfur, peroxide, metal oxide or radiation cure systems as is well known in the art. Most specifically preferred are polyurethane polymeric matrix binders within the range of both soft and rigid materials at a modulus ranging from about 2,000 psi (13.79 MPa) to about 8,000 psi (55.16 MPa).

The rigidity, impact and ballistic properties of the articles formed from the composites of the invention are affected by the tensile modulus of the polymeric binder polymer coating the fibers. For example, U.S. Pat. No. 4,623,574 discloses that fiber reinforced composites constructed with elastomeric matrices having tensile moduli less than about 6,000 psi (41,300 kPa) have superior ballistic properties compared both to composites constructed with higher modulus polymers, and also compared to the same fiber structure without a polymeric binder material. However, low tensile modulus polymeric binder material polymers also yield lower rigidity composites. Further, in certain applications, particularly those where a composite must function in both anti-ballistic and structural modes, there is needed a superior combination of ballistic resistance and rigidity. Accordingly, the most appropriate type of polymeric binder polymer to be used will vary depending on the type of article to be formed from the composites of the invention. In order to achieve a compromise in both properties, a suitable polymeric binder may combine both low modulus and high modulus materials to form a single polymeric binder.

The polymeric binder material may be applied either simultaneously or sequentially to a plurality of fibers arranged as a fiber web (e.g. a parallel array or a felt) to form a coated web, applied to a woven fabric to form a coated woven fabric, or as another arrangement, to thereby impregnate the fiber layers with the binder. As used herein, the term “impregnated with” is synonymous with “embedded in” as well as “coated with” or otherwise applied with the coating where the binder material diffuses into the fiber layer and is not simply on a surface of the fiber layers. The polymeric material may also be applied onto at least one array of fibers that is not part of a fiber web, followed by weaving the fibers into a woven fabric or followed by formulating a non-woven fabric following the methods described previously herein. Techniques of forming woven and non-woven fiber plies, layers and fabrics are well known in the art.

Although not required, fibers forming woven fiber layers are at least partially coated with a polymeric binder, followed by a consolidation step similar to that conducted with non-woven fiber layers. Such a consolidation step may be conducted to merge multiple woven fiber layers with each other, or to further merge the binder with the fibers of said woven fabric. For example, a plurality of woven fiber layers do not necessarily have to be consolidated, and may be attached by other means, such as with a conventional adhesive, or by stitching.

Generally, a polymeric binder coating is necessary to efficiently merge, i.e. consolidate, a plurality of non-woven fiber plies. The polymeric binder material may be applied onto the entire surface area of the individual fibers or only onto a partial surface area of the fibers. Most preferably, the coating of the polymeric binder material is applied onto substantially all the surface area of each individual fiber forming a fiber layer of the invention. Where a fiber layer comprises a plurality of yarns, each fiber forming a single strand of yarn is preferably coated with the polymeric binder material.

Any appropriate application method may be utilized to apply the polymeric binder material and the term “coated” is not intended to limit the method by which the polymer layers are applied onto the filaments/fibers. The polymeric binder material is applied directly onto the fiber surfaces using any appropriate method that would be readily determined by one skilled in the art, and the binder then typically diffuses into the fiber layer as discussed herein. For example, the polymeric binder materials may be applied in solution, emulsion or dispersion form by spraying, extruding or roll coating a solution of the polymer material onto fiber surfaces, wherein a portion of the solution comprises the desired polymer or polymers and a portion of the solution comprises a solvent capable of dissolving or dispersing the polymer or polymers, followed by drying. Alternately, the polymeric binder material may be extruded onto the fibers using conventionally known techniques, such as through a slot-die, or through other techniques such as direct gravure, Meyer rod and air knife systems, which are well known in the art. Another method is to apply a neat polymer of the binder material onto fibers either as a liquid, a sticky solid or particles in suspension or as a fluidized bed. Alternatively, the coating may be applied as a solution, emulsion or dispersion in a suitable solvent which does not adversely affect the properties of fibers at the temperature of application. For example, the fibers can be transported through a solution of the polymeric binder material to substantially coat the fibers and then dried.

In another coating technique, the fibers may be dipped into a bath of a solution containing the polymeric binder material dissolved or dispersed in a suitable solvent, and then dried through evaporation or volatilization of the solvent. This method preferably at least partially coats each individual fiber with the polymeric material, preferably substantially coating or encapsulating each of the individual fibers and covering all or substantially all of the filament/fiber surface area with the polymeric binder material. The dipping procedure may be repeated several times as required to place a desired amount of polymer material onto the fibers.

Other techniques for applying a coating to the fibers may be used, including coating of a gel fiber precursor when appropriate, such as by passing the gel fiber through a solution of the appropriate coating polymer under conditions to attain the desired coating. Alternatively, the fibers may be extruded into a fluidized bed of an appropriate polymeric powder.

The fibers may be coated with the polymeric binder either before or after the fibers are arranged into one or more plies/layers, or before or after the fibers are woven into a woven fabric. Woven fabrics may be formed using techniques that are well known in the art using any fabric weave, such as plain weave, crowfoot weave, basket weave, satin weave, twill weave and the like. Plain weave is most common, where fibers are woven together in an orthogonal 0°/90° orientation. Either prior to or after weaving, the individual fibers of each woven fabric material may or may not be coated with the polymeric binder material. Typically, weaving of fabrics is performed prior to coating fibers with the polymeric binder, where the woven fabrics are thereby impregnated with the binder. However, the invention is not intended to be limited by the stage at which the polymeric binder is applied to the fibers, nor by the means used to apply the polymeric binder.

Methods for the production of non-woven fabrics are well known in the art. In the preferred embodiments herein, a plurality of fibers are arranged into at least one array, typically being arranged as a fiber web comprising a plurality of fibers aligned in a substantially parallel, unidirectional array. In a typical process for forming non-woven unidirectionally aligned fiber plies, fiber bundles are supplied from a creel and led through guides and one or more spreader bars into a collimating comb, followed by coating the fibers with a polymeric binder material. A typical fiber bundle will have from about 30 to about 2000 individual fibers. The spreader bars and collimating comb disperse and spread out the bundled fibers, reorganizing them side-by-side in a coplanar fashion. Ideal fiber spreading results in the individual filaments or individual fibers being positioned next to one another in a single fiber plane, forming a substantially unidirectional, parallel array of fibers without fibers overlapping each other. At this point, scouring the fibers before or during this spreading step may enhance and accelerate the spreading of the fibers into such a parallel array. Fiber scouring is a process in which fibers (or fabric) are passed through a chemical solution which removes any of the undesirable residual fiber finish (or weaving aid) that may have been applied to the fibers during or after fabrication. Fiber scouring may also improve the bond strength of a subsequently applied polymeric binder material (or a subsequently applied protective film) on the fibers, and accordingly, less binder may be needed. By reducing amount of binder, a greater number of fibers may be included in a fabric, producing a lighter ballistic material with improved strength. This also leads to increased projectile engagement with the fibers, improved stab resistance of resulting fabric composites and an increased resistance of the composites against repeated impacts. Following fiber spreading and collimating, the fibers of such a parallel array typically contain from about 3 to 12 fiber ends per inch (1.2 to 4.7 ends per cm), depending on the filament/fiber thickness.

After the fibers are coated with the binder material, the coated fibers are formed into non-woven fiber layers that comprise a plurality of overlapping, non-woven fiber plies that are consolidated into a single-layer, monolithic element. In a preferred non-woven fabric structure of the invention, a plurality of stacked, overlapping unitapes are formed wherein the parallel fibers of each single ply (unitape) are positioned orthogonally to the parallel fibers of each adjacent single ply relative to the longitudinal fiber direction of each single ply. The stack of overlapping non-woven fiber plies is consolidated under heat and pressure, or by adhering the coatings of individual fiber plies, to form a single-layer, monolithic element which has also been referred to in the art as a single-layer, consolidated network where a “consolidated network” describes a consolidated (merged) combination of fiber plies with the polymeric matrix/binder. Articles of the invention may also comprise hybrid consolidated combinations of woven fabrics and non-woven fabrics, as well as combinations of non-woven fabrics formed from unidirectional fiber plies and non-woven felt fabrics.

Most typically, non-woven fiber layers or fabrics include from 1 to about 6 plies, but may include as many as about 10 to about 20 plies as may be desired for various applications. The greater the number of plies translates into greater ballistic resistance, but also greater weight. Accordingly, the number of fiber plies forming a fiber layer composite and/or fabric composite or an article of the invention varies depending upon the ultimate use of the fabric or article. For example, in body armor vests for military applications, in order to form an article composite that achieves a desired 1.0 pound per square foot or less areal density (4.9 kg/m²), a total of about 100 plies (or layers) to about 50 individual plies (or layers) may be required, wherein the plies/layers may be woven, knitted, felted or non-woven fabrics (with parallel oriented fibers or other arrangements) formed from the high-strength fibers described herein. In another embodiment, body armor vests for law enforcement use may have a number of plies/layers based on the National Institute of Justice (NIJ) Threat Level. For example, for an NIJ Threat Level IIIA vest, there may be a total of 40 plies. For a lower NIJ Threat Level, fewer plies/layers may be employed. The invention allows for the incorporation of a greater number of fiber plies to achieve the desired level of ballistic protection without increasing the fabric weight as compared to other known ballistic resistant structures.

As is conventionally known in the art, excellent ballistic resistance is achieved when individual fiber plies are cross-plied such that the fiber alignment direction of one ply is rotated at an angle with respect to the fiber alignment direction of another ply. Most preferably, the fiber plies are cross-plied orthogonally at 0° and 90° angles, but adjacent plies can be aligned at virtually any angle between about 0° and about 90° with respect to the longitudinal fiber direction of another ply. For example, a five ply non-woven structure may have plies oriented at a 0°/45°/90°/45°/0° or at other angles. Such rotated unidirectional alignments are described, for example, in U.S. Pat. Nos. 4,457,985; 4,748,064; 4,916,000; 4,403,012; 4,623,574; and 4,737,402, all of which are incorporated herein by reference to the extent not incompatible herewith.

Methods of consolidating fiber plies to form fiber layers and composites are well known, such as by the methods described in U.S. Pat. No. 6,642,159. Consolidation can occur via drying, cooling, heating, pressure or a combination thereof. Heat and/or pressure may not be necessary, as the fibers or fabric layers may just be glued together, as is the case in a wet lamination process. Typically, consolidation is done by positioning the individual fiber plies on one another under conditions of sufficient heat and pressure to cause the plies to combine into a unitary fabric. Consolidation may be done at temperatures ranging from about 50° C. to about 175° C., preferably from about 105° C. to about 175° C., and at pressures ranging from about 5 psig (0.034 MPa) to about 2500 psig (17 MPa), for from about 0.01 seconds to about 24 hours, preferably from about 0.02 seconds to about 2 hours. When heating, it is possible that the polymeric binder coating can be caused to stick or flow without completely melting. However, generally, if the polymeric binder material (if it is one that is capable of melting) is caused to melt, relatively little pressure is required to form the composite, while if the binder material is only heated to a sticking point, more pressure is typically required. As is conventionally known in the art, consolidation may be conducted in a calender set, a flat-bed laminator, a press or in an autoclave. Most commonly, a plurality of orthogonal fiber webs are “glued” together with the binder polymer and run through a flat bed laminator to improve the uniformity and strength of the bond. Further, the consolidation and polymer application/bonding steps may comprise two separate steps or a single consolidation/lamination step.

Alternately, consolidation may be achieved by molding under heat and pressure in a suitable molding apparatus. Generally, molding is conducted at a pressure of from about 50 psi (344.7 kPa) to about 5,000 psi (34,470 kPa), more preferably about 100 psi (689.5 kPa) to about 3,000 psi (20,680 kPa), most preferably from about 150 psi (1,034 kPa) to about 1,500 psi (10,340 kPa). Molding may alternately be conducted at higher pressures of from about 5,000 psi (34,470 kPa) to about 15,000 psi (103,410 kPa), more preferably from about 750 psi (5,171 kPa) to about 5,000 psi, and more preferably from about 1,000 psi to about 5,000 psi. The molding step may take from about 4 seconds to about 45 minutes. Preferred molding temperatures range from about 200° F. (˜93° C.) to about 350° F. (˜177° C.), more preferably at a temperature from about 200° F. to about 300° F. and most preferably at a temperature from about 200° F. to about 280° F. The pressure under which the fiber layers and fabric composites of the invention are molded typically has a direct effect on the stiffness or flexibility of the resulting molded product. Molding at a higher pressure generally produces stiffer materials, up to a certain limit. In addition to the molding pressure, the quantity, thickness and composition of the fiber plies and polymeric binder coating type also directly affects the stiffness of the articles formed from the composites.

While each of the molding and consolidation techniques described herein are similar, each process is different. Particularly, molding is a batch process and consolidation is a generally continuous process. Further, molding typically involves the use of a mold, such as a shaped mold or a match-die mold when forming a flat panel, and does not necessarily result in a planar product. Normally consolidation is done in a flat-bed laminator, a calendar nip set or as a wet lamination to produce soft (flexible) body armor fabrics. Molding is typically reserved for the manufacture of hard armor, e.g. rigid plates. In either process, suitable temperatures, pressures and times are generally dependent on the type of polymeric binder coating materials, polymeric binder content, process used and fiber type.

To produce a fabric article having sufficient ballistic resistance properties, the total weight of the binder/matrix coating preferably comprises from about 2% to about 50% by weight, more preferably from about 5% to about 30%, more preferably from about 7% to about 20%, and most preferably from about 11% to about 16% by weight of the fibers plus the weight of the coating, wherein 16% is most preferred for non-woven fabrics. A lower binder/matrix content is appropriate for woven fabrics, wherein a polymeric binder content of greater than zero but less than 10% by weight of the fibers plus the weight of the coating is typically most preferred. This is not intended as limiting. For example, phenolic/PVB impregnated woven aramid fabrics are sometimes fabricated with a higher resin content of from about 20% to about 30%, although around 12% content is typically preferred.

As stated above, the thermoplastic overlay may be, for example, a discontinuous thermoplastic web, an ordered discontinuous thermoplastic net, a non-woven discontinuous fabric, a non-woven discontinuous scrim, a discontinuous melted powder, a porous film or a plurality of thermoplastic polymer strips. Suitable polymers for the thermoplastic overlay non-exclusively include thermoplastic polymers non-exclusively may be selected from the group consisting of polyolefins, polyamides, polyesters (particularly polyethylene terephthalate (PET) and PET copolymers), polyurethanes, vinyl polymers, ethylene vinyl alcohol copolymers, ethylene octane copolymers, acrylonitrile copolymers, acrylic polymers, vinyl polymers, polycarbonates, polystyrenes, fluoropolymers and the like, as well as co-polymers and mixtures thereof, including ethylene vinyl acetate (EVA) and ethylene acrylic acid. Also useful are natural and synthetic rubber polymers. Of these, polyolefin and polyamide layers are preferred. The preferred polyolefin is a polyethylene. Non-limiting examples of useful polyethylenes are low density polyethylene (LDPE), linear low density polyethylene (LLDPE), Medium Density Polyethylene (MDPE), linear medium density polyethylene (LMDPE), linear very-low density polyethylene (VLDPE), linear ultra-low density polyethylene (ULDPE), high density polyethylene (HDPE) and co-polymers and mixtures thereof. Of these, the most preferred polyethylene is MDPE.

Most preferably the thermoplastic overlay is a heat-activated, non-woven, adhesive web, such as SPUNFAB®, commercially available from Spunfab, Ltd, of Cuyahoga Falls, Ohio (trademark registered to Keuchel Associates, Inc.). Also suitable are THERMOPLAST™ and HELIOPLAST™ webs, nets and films, commercially available from Protechnic S.A. of Cernay, France. Of all the above, most preferred is a polyamide web, particularly SPUNFAB® polyamide webs. SPUNFAB® polyamide webs have a melting point of typically from about 75° C. to about 200° C., but this is not limiting.

The thermoplastic overlay is preferably bonded to the fiber layer using well known techniques, such as thermal lamination. Typically, laminating is done by positioning the individual layers on one another under conditions of sufficient heat and pressure to cause the layers to combine into a unitary film. The individual layers are positioned on one another, and the combination is then typically passed through the nip of a pair of heated laminating rollers by techniques well known in the art. Lamination heating may be done at temperatures ranging from about 95° C. to about 175° C., preferably from about 105° C. to about 175° C., at pressures ranging from about 5 psig (0.034 MPa) to about 100 psig (0.69 MPa), for from about 5 seconds to about 36 hours, preferably from about 30 seconds to about 24 hours.

The thermoplastic overlay on a fibrous composite surface is preferably very thin, having a preferred layer thickness of from about 1 μm to about 250 μm, more preferably from about 5 μm to about 25 μm and most preferably from about 5 μm to about 9 μm. It should be understood, however, that these thicknesses are not necessarily descriptive of non-continuous webs. For example, SPUNFAB® webs are several mils thick where material is present, but most of the web is just air. These materials are better described by their basis weight, e.g. particularly preferred is a SPUNFAB® web having a basis weight of 6 grams per square meter (gsm). The thickness of the individual fiber layers will correspond to the thickness of the individual fibers. While such thicknesses are preferred, it is to be understood that other thicknesses may be produced to satisfy a particular need and yet fall within the scope of the present invention. The thermoplastic overlay preferably comprises from about 1% to about 25% by weight of the overall composite, more preferably from about 1% to about 17% percent by weight of the overall composite and most preferably from 1% to 12%, based on the weight of the fibrous composite plus the weight of the overlay(s). The percent by weight of the polymer film layers will generally vary depending on the number of fiber layers and overlays included. For example, a 6 gsm SPUNFAB® layer consists of just over 1 wt. % of a 500 gsm final product.

The thickness of the fibrous composite will correspond to the thickness of the individual fibers and the number of fiber layers incorporated into a fabric. A preferred woven fabric will have a preferred thickness of from about 25 μm to about 600 μm per layer, more preferably from about 50 μm to about 385 μm and most preferably from about 75 μm to about 255 μm per layer. A preferred non-woven fabric, i.e. a non-woven, single-layer, consolidated network, will have a preferred thickness of from about 12 μm to about 600 μm, more preferably from about 50 μm to about 385 μm and most preferably from about 75 μm to about 255 μm, wherein a single-layer, consolidated network typically includes two consolidated plies (i.e. two unitapes). While such thicknesses are preferred, it is to be understood that other thicknesses may be produced to satisfy a particular need and yet fall within the scope of the present invention.

The fibrous composites of the invention will have a preferred areal density of from about 20 grams/m² (0.004 lb/ft² (psf)) to about 1000 gsm (0.2 psf). More preferable areal densities for the fabrics/composites of this invention will range from about 30 gsm (0.006 psf) to about 500 gsm (0.1 psf). The most preferred areal density for fabrics/composites of this invention will range from about 50 gsm (0.01 psf) to about 250 gsm (0.05 psf). Articles of the invention comprising multiple fiber layers stacked one upon another and consolidated will further have a preferred areal density of from about 1000 gsm (0.2 psf) to about 40,000 gsm (8.0 psf), more preferably from about 2000 gsm (0.40 psf) to about 30,000 gsm (6.0 psf), more preferably from about 3000 gsm (0.60 psf) to about 20,000 gsm (4.0 psf), and most preferably from about 3750 gsm (0.75 psf) to about 15,000 gsm (3.0 psf). A typical range for composite articles shaped into helmets is from about 7,500 gsm (1.50 psf) to about 12,500 gsm (2.50 psf).

The fabrics of the invention may be used in various applications to form a variety of different ballistic resistant articles using well known techniques, including flexible, soft armor articles as well as rigid, hard armor articles. For example, suitable techniques for forming ballistic resistant articles are described in, for example, U.S. Pat. Nos. 4,623,574, 4,650,710, 4,748,064, 5,552,208, 5,587,230, 6,642,159, 6,841,492 and 6,846,758, all of which are incorporated herein by reference to the extent not incompatible herewith.

The following examples serve to illustrate the invention:

### Example 1

A non-woven web of SPUNFAB® heat-activated adhesive web, commercially available from Keuchel Associates, Inc. of Cuyahoga Falls, Ohio, is attached to a single outer surface of a consolidated, polyethylene fiber-based non-woven fabric comprising fibers coated with a polar, hydrolytically stable polyurethane polymeric binder material. The adhesive web is attached to the fabric at 225° F. (107.2)° and 50 PSI (344.7 kPa) through a flat-bed laminator.

### Example 2

Example 1 is repeated except the SPUNFAB® is attached to both outer surfaces of the non-woven composite.

### Example 3

A non-woven web of SPUNFAB® heat-activated adhesive web is attached to a single outer surface of a consolidated, polyethylene fiber-based non-woven fabric comprising fibers coated with a fluorine-containing polymeric binder material. The adhesive web is attached to the fabric at 225° F. (107.2)° and 50 PSI (344.7 kPa) through a flat-bed laminator.

### Example 4

Example 3 is repeated except the SPUNFAB® is attached to both outer surfaces of the non-woven composite.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

1. A ballistic resistant article comprising:
a) a fibrous composite comprising at least one fiber layer, each fiber layer comprising a plurality of fibers and a polymeric binder material on a surface of and surrounding the fibers; said fibrous composite having an outer top surface and an outer bottom surface; and
b) at least one thermoplastic overlay bonded to said outer top surface, or bonded to said outer bottom surface, or bonded to both said outer top surface and said outer bottom surface, wherein said at least one thermoplastic overlay only partially covers said outer top surface, said outer bottom surface, or both said outer top surface and said outer bottom surface,
wherein a portion of said polymeric binder material is exposed through said at least one thermoplastic overlay.

2. The ballistic resistant article of claim 1 wherein a thermoplastic overlay is bonded to both said outer top surface and said outer bottom surface.

3. The ballistic resistant article of claim 1 wherein the overlay is a non-woven discontinuous scrim.

4. The ballistic resistant article of claim 1 wherein the overlay comprises a discontinuous thermoplastic web, an ordered discontinuous thermoplastic net, a non-woven discontinuous fabric, a non-woven discontinuous scrim, a discontinuous melted powder, or a plurality of thermoplastic polymer strips.

5. The ballistic resistant article of claim 1 wherein the overlay comprises a discontinuous thermoplastic scrim.

6. The ballistic resistant article of claim 1 wherein the fibrous composite comprises one or more non-woven fiber layers.

7. The ballistic resistant article of claim 1 wherein the fibrous composite comprises one or more woven fiber layers.

8. The ballistic resistant article of claim 1 wherein the fibrous composite comprises a plurality of fiber layers, wherein a continuous polymeric film is present between each fiber layer.

9. The ballistic resistant article of claim 1 wherein the polymeric binder material is resistant to dissolution by water.

10. The ballistic resistant article of claim 1 wherein the polymeric binder material is resistant to dissolution by one or more organic solvents.

11. The ballistic resistant article of claim 1 wherein the polymeric binder material comprises a hydrolytically stable, polar polyurethane that is resistant to dissolution by water and resistant to dissolution by one or more organic solvents.

12. The ballistic resistant article of claim 1 wherein the polymeric binder material consists of a fluorine-containing material, and wherein the at least one thermoplastic overlay comprises from 1 wt. % to 17 wt. % based on the weight of the fibrous composite plus the weight of the at least one thermoplastic overlay.

13. The ballistic resistant article of claim 1 wherein the polymeric binder material comprises a nitrile rubber, and wherein the at least one thermoplastic overlay comprises from 1 wt. % to 12 wt. % based on the weight of the fibrous composite plus the weight of the at least one thermoplastic overlay.

14. The ballistic resistant article of claim 1 wherein said fibers have a tenacity of about 7 g/denier or more and a tensile modulus of about 150 g/denier or more, and wherein the overlay is a discontinuous melted powder.

15. The ballistic resistant article of claim 1 wherein the polymeric binder material comprises from about 2% to about 50% by weight of said fibrous composite, wherein the polymeric binder material encapsulates the fibers whereby it covers all surface area of the fibers.

16. The ballistic resistant article of claim 1 wherein the polymeric binder material comprises from about 7% to about 20% by weight of said fibrous composite, wherein the polymeric binder material encapsulates the fibers whereby it covers all surface area of the fibers, and wherein the composite has an areal density of from 50 g/m² (0.01 lb/ft²) to 250 g/m² (0.05 lb/ft²).

17. A method of producing a ballistic resistant article, comprising:
a) providing a fibrous composite comprising at least one fiber layer, each fiber layer comprising a plurality of fibers and a polymeric binder material on a surface of and surrounding the fibers; said fibrous composite having an outer top surface and an outer bottom surface;
b) applying at least one thermoplastic overlay onto said outer top surface, or onto said outer bottom surface, or onto both said outer top surface and said outer bottom surface such that said at least one thermoplastic overlay only partially covers said outer top surface, said outer bottom surface, or both said outer top surface and said outer bottom surface; and
c) bonding the at least one thermoplastic overlay to said outer top surface, said outer bottom surface, or both said outer top surface and said outer bottom surface,
wherein the overlay comprises a discontinuous thermoplastic web, an ordered discontinuous thermoplastic net, a non-woven discontinuous fabric, a non-woven discontinuous scrim, a discontinuous melted powder, or a plurality of thermoplastic polymer strips, and wherein a portion of said polymeric binder material is exposed through said at least one thermoplastic overlay.

18. The method of claim 17 wherein at least one thermoplastic overlay is bonded to both said outer top surface and said outer bottom surface.

19. (canceled)

20. A ballistic resistant article comprising:
a) a fibrous composite comprising at least one fiber layer, each fiber layer comprising a plurality of fibers, said fibrous composite having an outer top surface and an outer bottom surface; and
b) at least one thermoplastic overlay bonded to said outer top surface, or bonded to said outer bottom surface, or bonded to both said outer top surface and said outer bottom surface, wherein said at least one thermoplastic overlay only partially covers said outer top surface, said outer bottom surface, or both said outer top surface and said outer bottom surface,
wherein the overlay comprises a discontinuous thermoplastic web, an ordered discontinuous thermoplastic net, a non-woven discontinuous fabric, a non-woven discontinuous scrim, a discontinuous melted powder, or a plurality of thermoplastic polymer strips, and
wherein a continuous polymeric film is present between each fiber layer.

21. The ballistic resistant article of claim 20 wherein said article comprises, in order:
i) a first non-woven discontinuous scrim;
ii) a first single-ply of unidirectionally oriented fibers bonded to the first non-woven discontinuous scrim;
iii) a continuous polymeric film bonded to the first single-ply of unidirectionally oriented fibers;
iv) a second single-ply of unidirectionally oriented fibers bonded to the continuous polymeric film; and
v) a second non-woven discontinuous scrim bonded to the second single-ply of unidirectionally oriented fibers,
wherein the fibers of the first single-ply of unidirectionally oriented fibers are oriented at 90° relative to the fibers of the second single-ply of unidirectionally oriented fibers.
